(19) United States
(12) Patent Application Publication
(10) Pub. No.: US 2020/0250386 A1
(43) Pub. Date: Aug. 6, 2020

(54) SELF-RIGHTING RADIO TRACKING TAGS FOR MEASURING FLOWS

(71) Applicants: Bruce MACVICAR, Waterloo, CA (US); Christopher Muirhead, Waterloo (CA)

(72) Inventors: Bruce MACVICAR, Waterloo, CA (US); Christopher Muirhead, Waterloo (CA)

(21) Appl. No.: 16/782,302

(22) Filed: Feb. 5, 2020

Related U.S. Application Data
(60) Provisional application No. 62/801,277, filed on Feb. 5, 2019.

(51) Int. Cl. G06K 7/10; G01D 3/028

(52) U.S. Cl. CPC G06K 7/10099; G01D 3/028

(57) ABSTRACT

There is disclosed a self-righting radio frequency tracking tag. In an embodiment, an inner-sphere containing a radio frequency tag is ballasted to maintain an optimal orientation of the radio frequency tag. An outer-sphere is adapted to encapsulate the inner-sphere and a lubricating liquid, whereby in use the inner-sphere freely rotates in the lubricating liquid within the outer-sphere. The lubricating liquid has a freezing temperature of −40° C., allowing the radio frequency tracking tag to be used in winter conditions. The radio frequency tracking tag can be encased in a synthetic mass, such as synthetic stone, to simulate stones as may be found on a riverbed, yet still allow the inner-sphere to freely rotate and keep the radio frequency tag optimally oriented.

### FIELD OF THE INVENTION

The present invention relates generally to radio frequency tracking tags for measuring flows.

### BACKGROUND

RFID technology has been widely used in river bed sediment tracking for over ten years in order to track bedload sediment. While RFID technology has allowed for increased monitoring capabilities, prior art tracking systems have several issues and limitations. One such issue is the variability in the detection field based on the orientation of the RFID tag.

What is needed is an improved RFID tracking tag for monitoring flows which addresses at least some of the limitations in the prior art.

### SUMMARY

The present invention relates to a self-righting radio frequency ID (RFID) tracking tag in which an RFID tag always maintains an optimal orientation for tracking utilizing a self-righting mechanism, thereby to provide an improved detection range of the RFID tracking tag.

In an embodiment, the self-righting mechanism is configured to allow for a RFID tracking tag to maintain an optimally (e.g. generally vertically) oriented position at all times by using a double-spherical design, in which a ballasted inner spherical shell or ball containing a RFID tracking tag rotates freely within an outer spherical shell or ball. A lubricating liquid with a very low freezing temperature lubricates the outer surface of the inner-sphere and the inner surface of the outer-sphere.

Advantageously the sphere-within-a-sphere configuration of the present RFID tracking tag ensures that the ballasted inner-sphere housing the RFID tag can always maintain the RFID tag in an optimal (e.g. a generally vertical) orientation even when the outer-sphere is prevented from rotating, for example when the outer-sphere or is embedded in a mass. This allows for greater RFID detection rates and increased accuracy in positioning the RFID tracking tags in the numerous types of applications for detecting flows.

In an embodiment, the inner-sphere comprises two half-spheres: a first half-sphere forming a receptacle base or holder for an RFID tag; and a second half-sphere forming a dome to encapsulate the RFID tag. The lower half-sphere of the inner-sphere is also ballasted with a solid material, such as a resin, before the two half-spheres are assembled and sealed together (e.g. using glue) to form the inner-sphere.

In an embodiment, the inner-sphere is placed inside an outer-sphere, which may itself be formed from two larger half-spheres. A lubricating liquid having a very low freezing temperature is placed inside the outer shell prior to the two half-spheres of the outer-sphere being sealed. The very low freezing temperature allows the lubricating liquid to remain a liquid in winter conditions, allowing the RFID tags to be used in temperatures as low as −40° C.

In an embodiment, the density of the components used in the RFID tracking tag design can be adjusted to provide a desired buoyancy for the application. For example, a very buoyant RFID tracking tag that can float in water may be used to track surface flows of a river, or other flow of liquid.

Alternatively, a neutral buoyancy RFID tracking tag may be selected to allow submersed RFID tracking tags to move freely in a liquid, such as a flow of water in a river, or in a sewer system.

Finally, the RFID tracking tags can be weighed to sink to the bottom of a body of a body of liquid, e.g. a riverbed, either by a suitable selection of materials for the inner and outer spheres, or by embedding the inner and outer spheres entirely within another mass, whether natural or synthetic. For example, a synthetic stone material may be formed around the RFID tracking tag to simulate stones that may lie on a riverbed and roll along with the bedload sediment.

Thus, some illustrative examples of use cases include tracking river bedload transport, tracking wooded debris and water flows in rivers, tracing flows in piped networks, and tracking discharge estimates in rivers and water level monitoring in contactless, closed systems.

In this respect, before explaining at least one embodiment of the invention in detail, it is to be understood that the invention is not limited in its applications to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a perspective view of half-spheres that when assembled together form an outer-sphere and an inner-sphere for a self-righting RFID tracking tag in accordance with an embodiment.

FIG. 2 shows a top view of the half-spheres of outer-spheres and inner-spheres of FIG. 1, together with an assembled sphere and a coin (i.e. a quarter) to show its relative size in accordance with an illustrative embodiment.

FIG. 3 shows a mold for producing the half-spheres of the outer-sphere and inner-sphere of FIG. 1 and FIG. 2.

FIG. 4 shows an assembled inner-sphere in the middle of two outer-sphere half-spheres before encapsulation.

FIG. 5 shows a cross-sectional illustration of an RFID tracking tag in accordance with an embodiment.

FIG. 6 shows a fully assembled RFID tracking tag comprising a self-righting inner-sphere encased in an outer-sphere.

FIG. 7 shows illustrative examples of the RFID tracking tag embedded in synthetic stone material in accordance with an embodiment.

### DETAILED DESCRIPTION

As noted above, the present invention relates to a self-righting radio frequency ID (RFID) tracking tag in which an RFID tag always maintains an optimal orientation (e.g. a generally vertical orientation) utilizing a ballast, in order to provide an improved detection range of the RFID tracking tag. The generally vertical orientation of the RFID tag is maintained even when the RFID tracking tag is embedded within an outer mass to weigh it down under water, thereby allowing for greater RFID detection rates and increased accuracy in positioning in the numerous types of applications.

In an embodiment, the inner-sphere consists of two half-spheres: a first half-sphere including a receptacle base or holder for an RFID tag; and a second half-sphere forming a dome to encapsulate the RFID tag. The lower half-sphere of the inner-sphere is also ballasted with a solid mixture (e.g. a resin) before the two half-spheres are glued together and sealed to form the inner-sphere or sphere.

In an embodiment, the inner-sphere is placed inside an outer spherical shell, which may itself be formed from two larger half-sphere shells. A lubricating liquid having a very low freezing temperature is poured into the outer shell prior to the two-halves of the outer spherical shell being sealed. The very low freezing temperature allows the liquid lubricant to remain a liquid in winter conditions, allowing the RFID tags to be used in temperatures as low as −40° C.

In an embodiment, the density of the components of the design can be adjusted to provide a desired buoyancy for the application. For example, a buoyant RFID tracking tag that can float in water may be used to track surface flows of a river, or other flow of liquid. Alternatively, a neutral buoyancy may be selected to allow submersed RFID tracking tags to move freely with a body of water. Finally, the RFID tracking tags can be weighed to sink to the bottom of a body of flowing water, e.g. a river bed, either by a suitable selection of materials for the inner and outer spheres, or by embedding the inner and outer spheres entirely within a mass, whether natural or synthetic.

Advantageously the sphere-within-a-sphere configuration of the presence RFID tracking tags ensures that the RFID tag housed within the inner sphere can always maintain a generally vertical orientation, thereby allowing for greater detection rates and increased accuracy in positioning in the numerous types of applications.

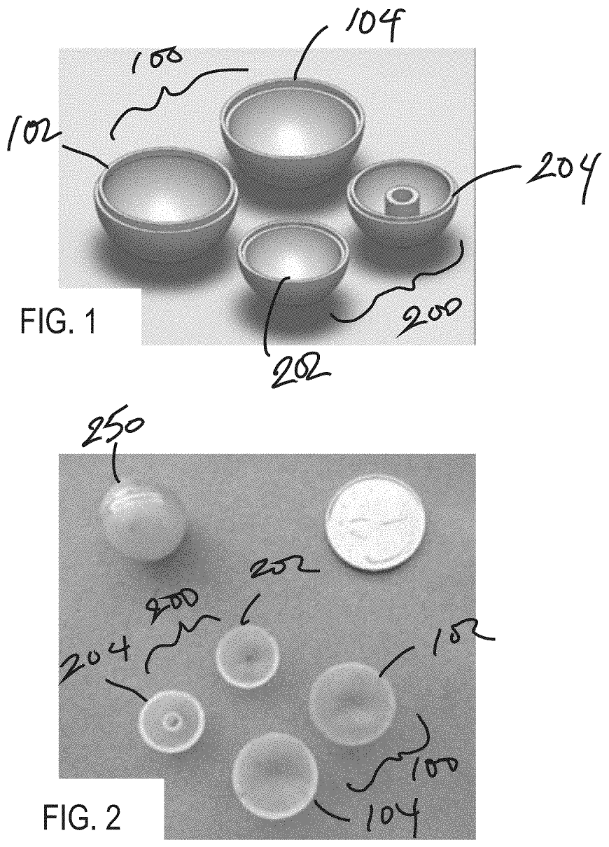

The self-righting mechanism is designed and constructed to allow for a RFID tracking to remain in a vertical position at all times. The design incorporates a sphere-within-a-sphere design, where the inner-sphere rotates within the outer-sphere. The inner-sphere consists of two halves, one with a placeholder for a RFID tracking. The lower half of the inner-sphere is weighted with a corundum powder and resin mixture before the two halves are glued together. The inner-sphere is placed inside the outer shell with a coating of a glycol mixture prior to the outer-sphere being sealed. The inner and outer-spheres are constructed with a custom injection mold designed specifically to create the smallest design possible while ensuring consistent rotation. FIG. 1 depicts several aspects of the construction process including the SolidWorks model and the mold used to print the design.

Illustrative embodiments of this RFID tracking tag will now be described with reference to the drawings.

FIG. 1 shows a perspective view of half-spheres of outer-spheres and inner-spheres for assembling a self-righting RFID tracking tag in accordance with an embodiment. As shown, two larger half-spheres 102, 104 form the outer-sphere, and two smaller half-spheres 202, 204 form the inner-sphere.

FIG. 2 shows a top view of the half-spheres 102, 104 of outer-spheres and half-spheres 202, 204 of the inner-spheres of FIG. 1, together with an assembled sphere 250 and an illustrative coin (a quarter) to show its relative size in accordance with an illustrative embodiment. By way of example, and not by way of limitation, the size of the assembled sphere 250 in this case is approximately 17 mm in diameter. Advantageously, this small size allows the sphere 250 to be embedded in smaller sized masses to simulate smaller stones on river beds.

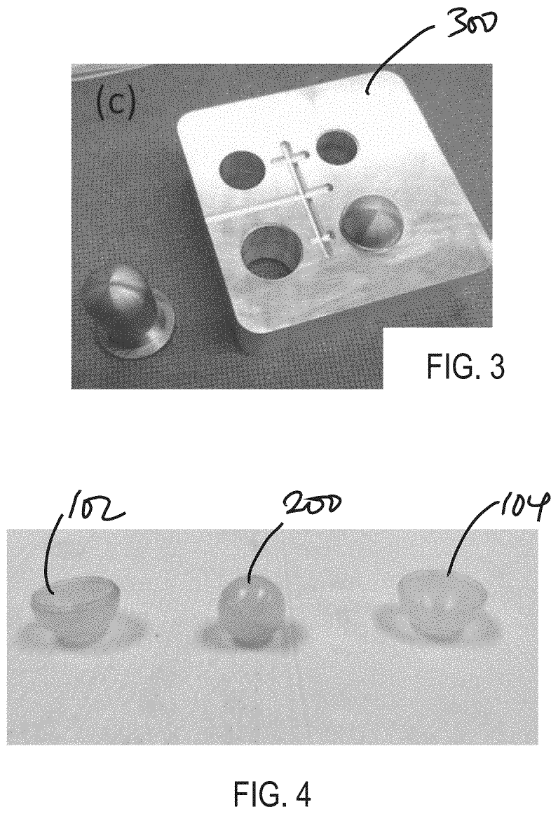

FIG. 3 shows a mold 300 for producing the half-spheres of outer-spheres and inner-spheres of FIG. 1 and FIG. 2 in accordance with an illustrative embodiment. The half-spheres 102, 104 of outer-sphere 100 and half-spheres 202, 204 of the inner-sphere 200 may thus be made from injection-molded plastic materials, or other materials that may be molded into shape.

As an illustrative example, half-spheres 102, 104 of outer-sphere 100 and half-spheres 202, 204 of the inner-sphere 200 are composed of High Density Polyethelyne (HDPE) plastic, custom molded to fit an RFID tag. HDPE has the durability to withstand exposure to the elements as well as the chemical heat associated with molding an outer casing around the assembled sphere 250. However, it will be appreciated that other materials and manufacturing methods may also be used, including any type of additive or subtractive manufacturing techniques which may form these components.

FIG. 4 shows an illustrative example of an assembled inner-sphere 200 in the middle of two-spheres 102, 104 outer-spheres. As shown, the inner-sphere 200 is sized to freely rotate and move within the outer-sphere 100 once assembled and encapsulated.

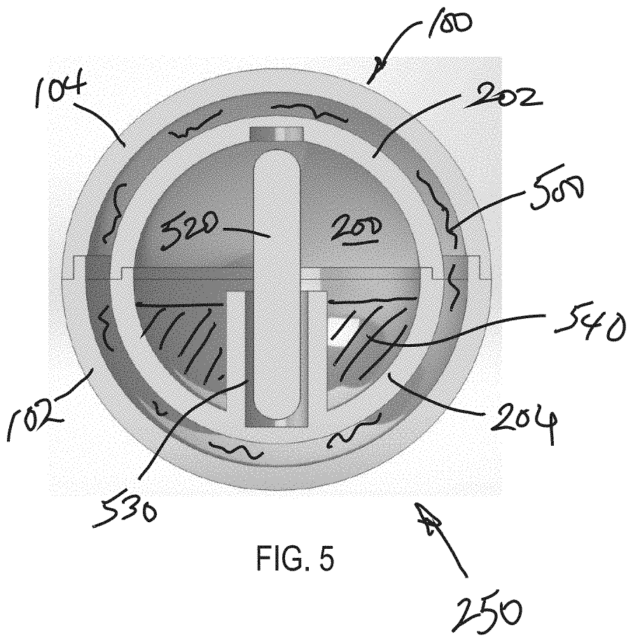

FIG. 5 shows a cross-sectional illustration of an RFID tracking tag in accordance with an embodiment. As shown, the two half-spheres 202, 204 of the inner-sphere are assembled inside the two half-spheres 102, 104 of the outer-sphere 100. A fluid 500 having a very low freezing temperature is placed inside the outer-sphere 100, but outside the inner-sphere 200.

As an illustrative example, the lubricant 500 may be 70% glycerin and 30% water. This solution forms a viscous fluid with a freezing point of −40° C. The freezing point of this solution is integral to the design as it allows for functionality of the design outdoors year-round without removal. However, it will be appreciated that any suitable lubricant may be used that performs the same function of allowing the inner-sphere 200 to freely rotate within the outer-sphere 100.

Still referring to FIG. 5, as shown, an RFID tag 520 is positioned in a receptacle 530 with a generally vertical orientation. A ballast material 540 weighs the inner-sphere 200 such that the inner-sphere will always self-right itself to maintain the orientation shown. The ballast material 540 should be nonmagnetic, as otherwise it may interfere with the RFID tracking communication.

As an illustrative example, the ballast material 540 may be a corundum powder resin developed from a 4:1 mixture of Aluminum Oxide powder and filled Urethane Resin. Aluminum Oxide powder was chosen specifically due to the high density of the powder, allowing for better rotation of the inner-sphere, and the non-magnetic nature of the powder. However, it will be appreciated that any suitable ballast material which is nonmagnetic may also be used in place of this particular resin.

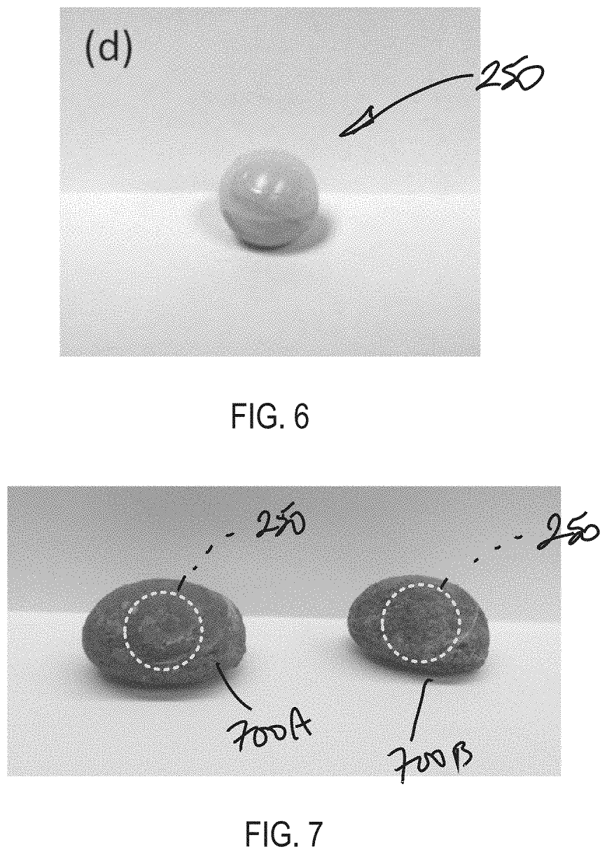

Now referring to FIG. 6, shown is a fully assembled RFID tracking tag comprising a self-righting inner-sphere encased in an outer-sphere. As discussed above, the self-righting mechanism is designed and constructed to allow for a RFID tracking tag to remain in a generally vertically oriented position at all times by using a double-spherical design, in which an inner spherical shell or ball containing the RFID tracking tag with a weighted bottom rotates freely within an outer spherical shell or ball containing fluid to lubricate the outer surface of the inner-sphere and the inner surface of the outer-sphere. This sphere-within-a-sphere design allows the inner-sphere or sphere to float in a lubricating liquid and rotate within the outer-sphere even when the outer-sphere itself is immobile and embedded in a mass to weigh down the RFID tracking tag. As an illustrative example, the RFID tracking tag may be encased in synthetic stone material as shown in FIG. 7, to simulate stones 700A, 700B that may lie on a river bed. The synthetic stones may be formed into various different shapes to simulate the shape and size of stones typically found in a river to be monitored and traced.

While tracking the flow of river beds has been described by way of example, various other application include tracking bed load transport, wooded debris and water flows in rivers, tracing flow in piped networks, discharge estimates in rivers and water level monitoring in contactless, closed systems.

Various changes and modifications may be made without departing from the scope of the invention, which is defined by the following claims.

1. A radio frequency tracking tag, comprising:
an inner-sphere containing a radio frequency tag, the inner-sphere having a ballast to maintain an optimal orientation of the radio frequency tag; and
an outer-sphere adapted to encapsulate the inner-sphere and a lubricating liquid, whereby in use the inner-sphere freely rotates in the lubricating liquid within the outer-sphere.

2. The radio frequency tracking tag of claim 1, wherein the radio frequency tag is an RFID tag.

3. The radio frequency tracking tag of claim 1, wherein the lubricating liquid has a freezing temperature of −40° C.

4. The radio frequency tracking tag of claim 1, wherein the ballast is a non-magnetic resin.

5. The radio frequency tracking tag of claim 1, wherein the outer-sphere is further encased in a synthetic mass.
